(19) United States
(12) Patent Application Publication
(10) Pub. No.: US 2012/0069464 A1
(43) Pub. Date: Mar. 22, 2012

(54) LIGHT SHIELDING DEVICE AND LIGHT SHIELDING METHOD

(76) Inventor: Hideyo Murakami, Fukuoka (JP)

(21) Appl. No.: 13/259,986

(22) PCT Filed: Oct. 19, 2009
(86) PCT No.: PCT/JP2009/068008

§ 371 Date: Sep. 23, 2011

(30) Foreign Application Priority Data
Mar. 31, 2009 (JP) PCT/JP2009/056673

(51) Int. Cl. G02B 7/183; G02B 7/188

(52) U.S. Cl. 359/849; 359/871

(57) ABSTRACT

Provided is a large scale light shielding device and a light shielding method for controlling weather. A light shielding device 1 includes a shielding member 11 that shields a part or all of spectrums of sunlight, a buoyant force imparting unit 13 having buoyant members 41, and a drive mechanism 15. The shielding member 11 includes, in order to shield the part or all of the spectrums of the sunlight, a light shielding unit 35 and a light transmitting unit 37. The drive mechanism 15 includes a driving unit 21 that settles or changes a position of the light shielding device 1, and a controlling unit 25 for the driving unit 21. Buoyant force is produced by the buoyant members 41, and imparted to the light shielding device 1 in a direction opposite of gravity due to an own weight of the main body. A magnitude of the buoyant force produced by the buoyant members 11 depends on a magnitude of gravity acting on the gas that is pushed aside by the buoyant members 11, and it is possible to cause the light shielding device 1 to float.

### TECHNICAL FIELD

The present invention relates to light shielding devices and light shielding methods, in particular, a light shielding device and a light shielding method capable of shielding sunlight in order to control weather.

### BACKGROUND ART

In recent years, in order to reduce the worldwide CO₂ emissions along with the global warming, various actions are taken energetically on a global basis including continued researches and developments, such as conversion of CO₂ into organic compounds by such as afforestation, as well as establishment of rules such as regulations of CO₂ emissions. In addition, extreme weather believed to be resulted from the global warming has been experienced. Typhoons are growing larger and larger and guerilla rains (sudden fierce downpours) occur due to urban heat islands.

In order to limit the damage caused by the extreme weather, various researches and developments are continued. Among others, technology for predicting typhoon movement and a reporting system of the predicted typhoon movement have already been completed in Japan. By contrast, since a part of the cause of guerilla rains occurring in the urban center is a large amount of heat generation due to power consumed for cooling and lighting in buildings in summer in the concerned area, it is difficult to predict occurrence of such guerilla rains, and therefore a method of predicting or preventing occurrence of guerilla rains has not been materialized yet.

The Earth is always heated by the sunlight. For example, the maximum sunlight power that can be received in Fukuoka in Japan is equal to about 800 watt per meter square per hour, and the maximum sunlight power that can be received on the Earth is equal to about 1,300 watt per meter square per hour. Further, the energy of 1,000 watt×hour is equal to about 0.860×10⁶ calories, which is an caloric energy that can increase temperature of 1 ton of water about 0.9 degrees centigrade, or that can evaporate 1 liter of water at ordinary temperature. Moreover, provided that only 10 cm thickness of surface water in the sea is heated, the energy of 1,000 watt×hour can heat temperature up about 9 degrees centigrade. In other words, in a tropical region, a region where sunlight energy of about no smaller than 1,000 watt per meter square is given is always heated by the sunlight, and thus shielding the sunlight energy in this region corresponds to cooling this region by about 1,000 watt per meter square per one hour.

In order to prevent the warming itself, a shielding effect using clouds and a shielding method by releasing a large amount of fine powder in the atmosphere, which provide an immediate effect, are merely studied. Further, the technology of casting a shadow by shielding sunlight to cool the shadowed area have been realized until now by a window shade, a blind, a drape, and the like. Casting a shadow over a wide area is materialized generally by using a method of constantly covering the area within a building or under a dome. In order to make a shadow over a small area, for example, of 5 meters long and 10 meters wide, a tent is usually set up. Patent Document 1 is listed as one example of the related art documents.

### PRIOR ART DOCUMENTS

### Patent Documents

Patent Document 1: Japanese Unexamined Patent Application Publication No. H09-170308

### SUMMARY OF THE INVENTION

### Problems to be Solved by the Invention

However, the conventional technology requires a supporting mechanism for supporting the weight of a shielding member that shields the light. Considering a sunshade or protection from the Sun over the buildings and like, the larger the area over which the shadow is cast, the more robust the supporting mechanism is required to be in order to support the load due to own weight of the shielding member, and thus durability of the supporting mechanism has to be taken into account.

In view of the above circumstance, an object of the present invention is to provide a large-scale light shielding device and a light shielding method for controlling weather.

### Means for Solving the Problems

A first aspect in accordance with the present invention provides a light shielding device, comprising a shielding member configured to shield a spectrum of sunlight at a predetermined altitude so as to change weather, the predetermined altitude being a high altitude no lower than 100 m above the ground, and the shielding member having a function of reflecting and radiating a part or all of sunlight to itself toward a cosmic space, and a buoyant force imparting unit configured to impart buoyant force to the shielding member, the buoyant force being imparted in a direction opposite of an own weight of the shielding member, the buoyant force imparting unit including a plurality of buoyant members provided for the light shielding device in a distributed manner and each filled with gas lighter than air, and being configured to maintain the shielding member and an object that is engaged with the shielding member in a floating state in which the shielding member and the object are in a non-contact state with a surface of the ground, wherein a part or all of the buoyant members constitute a main body of the light shielding device.

A second aspect in accordance with the present invention provides the light shielding device of the first aspect, wherein the part or all of the buoyant members are adjusted so that an internal pressure of the gas lighter than the air in each of the buoyant members that constitute the main body of the light shielding device is lower than an outside atmospheric pressure on the surface of the ground and higher than the outside atmospheric pressure at the predetermined altitude, thereby maintaining a strength for keeping a shape at the predetermined altitude.

A third aspect in accordance with the present invention provides the light shielding device of the first or the second aspect, wherein the buoyant force imparting unit includes a buoyant member controlling unit configured to balance between buoyant force of each of the buoyant members and own weight due to gravity of the main body of the light shielding device at a corresponding portion, and each of the buoyant members includes a gas adjusting unit configured to individually adjust an amount of the gas lighter than the air filled into the corresponding buoyant member.

A fourth aspect in accordance with the present invention provides the light shielding device of any of the first to the third aspects, wherein the spectrum of the sunlight is shielded at a plurality of altitudes, and each of the buoyant members that constitute the main body of the light shielding device is adjusted so that an internal pressure of the gas lighter than the air in the buoyant member is higher than an outside atmospheric pressure at one or more of the plurality of altitudes.

A fifth aspect in accordance with the present invention provides the light shielding device of any of the first to the fourth aspects, further comprising a light shielding device rotating unit configured to rotate the light shielding device, wherein a strength for keeping a shape is maintained also by a mechanism configured to pull the main body of the light shielding device outwardly by centrifugal force produced by the light shielding device rotating unit causing the light shielding device to rotate.

A sixth aspect in accordance with the present invention provides the light shielding device of any of the first to the fifth aspects, wherein the shielding member includes an opening configured to allow passing of wind and/or dropping of water through toward the ground.

A seventh aspect in accordance with the present invention provides the light shielding device of the sixth aspect, wherein the opening includes a valve, and the valve opens in a case in which wind passes and/or water drops through toward the ground.

An eighth aspect in accordance with the present invention provides the light shielding device of any of the first to the seventh aspects, wherein a part or all of a surface of the shielding member is colored so as to absorb and shield the sunlight, and converting an absorbed sunlight energy into heat increases a temperature of the gas lighter than the air.

A ninth aspect in accordance with the present invention provides the light shielding device of the eighth aspect, wherein an inner surface of a lower section, instead of an outer surface of an upper section, of the buoyant member is colored, and the temperature of the gas lighter than the air is increased also by a sunlight energy absorbed by coloring of the buoyant members.

A tenth aspect in accordance with the present invention provides the light shielding device of any of the first to the ninth aspects, wherein the buoyant member is configured by a soft film that prevents the gas filled therein from transmitting at the predetermined altitude, and the shielding member is configured in a form of a film so as to save weight.

An eleventh aspect in accordance with the present invention provides the light shielding device of any of the first to the tenth aspects, further comprising a driving unit configured to move the light shielding device, a movement controlling unit configured to control the movement of the shielding member by the driving unit, a position detecting unit configured to detect a position of the shielding member, and a position inputting unit configured to input information on a predetermined position on the Earth, wherein the movement controlling unit uses an output of the detection by the position detecting unit to make the shielding member move to a position inputted by the position inputting unit, move to and settle at the position inputted by the position inputting unit, or settle at the position inputted by the position inputting unit without moving.

A twelfth aspect in accordance with the present invention provides the light shielding device of any of the first to the eleventh aspects, further comprising a driving unit configured to move the light shielding device, a movement controlling unit configured to control the movement of the light shielding device by the driving unit, and a surface temperature measuring unit configured to measure a surface temperature on the Earth, wherein the movement controlling unit moves the light shielding device based on the surface temperature of the Earth measured by the surface temperature measuring unit.

A thirteenth aspect in accordance with the present invention provides a light shielding method using, in order to change weather, a light shielding device having a shielding member configured to shield a spectrum of sunlight and a buoyant force imparting unit configured to impart buoyant force to the shielding member to put the shielding member into a floating state, the shielding member being configured by a film material, the floating state being a situation in which the shielding member and an object that is engaged with the shielding member are in a non-contact state with a surface of the ground, the buoyant force imparting unit including a plurality of buoyant members each filled with gas lighter than air, the plurality of buoyant members being provided in a distributed manner, and constituting a part or all of a main body of the light shielding device, and including gas adjusting unit configured to individually adjust an amount of the gas lighter than the air, the method comprising a step of imparting the buoyant force to the shielding member while balancing between the buoyant force of the plurality of the buoyant members provided in the distributed manner and own weight due to gravity of the main body of the light shielding device at corresponding portions by individually adjusting the amount of the gas lighter than the air filled in each buoyant member with the gas adjusting unit.

A fourteenth aspect in accordance with the present invention provides the light shielding method of the thirteenth aspect, further comprising a step of making the shielding member to which the buoyant force is imparted locate at a position no lower than 1 km above the surface of the ground and reflect the sunlight outside of the Earth.

Now, providing the plurality of buoyant members is supplementarily explained. There is a case in which it is difficult to cause the device to float using a single buoyant member since the own weight of the main body of the device is heavy. In this case, for example, the device can be configured such that, at an altitude at which the device is planned to be installed, the buoyant members are distributed in whole each in an area of 5 m×5 m to produce buoyant force, and buoyant force of a total 400 of buoyant members in 100 m square is made to be substantially the same as the own weight and balanced with the own weight. With this, it is possible to avoid a large stress being imparted to a particular portion. Further, even if some of the plurality of the members are damaged and broken, this may not pose a problem for the buoyant force as a whole. Moreover, in order to spread the device of the size as above described, it is necessary to provide a lightweight frame or framework, and it is considered to use a tube (bag) that is filled with gas and strained tightly with tension or foamed polystyrene as the buoyant member, specifically. With this, as described in embodiments, it is possible to fold the device and causes the device to hang by its own weight by remotely controlling to suction the gas such as helium from a portion which is desired to be made heavier using a cylinder at an installation position at a certain altitude.

Furthermore, when the light shielding device is in the floating state, the device immediately faces a problem as described below. Specifically, the device faces a problem that how such a floating type light shielding device can remain stably floating up in the air where the device can be subjected to strong wind and downpour.

The stability here includes at least three aspects as described below.

First, it is positional stability in directions parallel with (X axis direction and Y axis direction) and a direction vertical to (Z axis direction) the surface of the ground.

The density of the atmosphere on the Earth reduces in accordance with a height from the surface of the ground. Further, as can be seen from the fact that jet engine airplanes normally fly at about 10000 meters above the ground, it does not rain and there is only steady air current, in particular, at about 10000 meters and higher above the ground, and substantially stable. Even in a typhoon, a jet engine airplane flies above the typhoon. Therefore, by installing the light shielding device at an altitude from about 10000 meters to 20000 meters, the device stably floats and moves since there is substantially no windblast although the device is drifted by an air flow. If it is a problem that the device is drifted, it is necessary to provide the light shielding device with a moving power by the driving unit to apply force toward a direction against the air flow. Moreover, in order to cast a shadow over a fixed area, it is necessary to constantly control the position of the light shielding device since the Sun constantly moves. In a case in which the shadow should be cast over a specific area instead of a specific place, the shadow can be cast according to the movement of the Sun and the drift of the light shielding device.

Furthermore, as an actual device, the light shielding device has a horizontal and vertical size. Therefore, when the light shielding device is inclined with respect to the horizontal plane, an end that has risen upward due to the inclination is pulled downward, since its position is high, the air density is low, and the buoyant force is smaller than that at a normal position. Further, an end that has lowered due to the inclination is pulled upward, since its position is low, the air density is high, and the buoyant force is greater than that at the normal position. Therefore, the light shielding device has a characteristic that the device is stable with respect to the horizontal plane. Moreover, the rotation of the light shielding device within the horizontal plane does not pose a large problem. It is not necessary to cast a detailed shadow along blocks in a city, and the place to which the shadow is cast can be a part of the city, desert, an agriculture region, or a fishery region. Therefore, the light shielding device can be installed substantially stably as long as it is installed at 10000 meters or more above the ground. By contrast, the operation at a position at 10000 meters or lower is carried out based on characteristics of wind, geography, and the installation place of the position considering such as the size of the light shielding device.

### Effects of the Invention

According to the present invention, it is possible to provide the shielding member with buoyant force, thereby allowing the shielding member to float in the air. Then, as the shielding member can float in the air, it is possible to cast a shadow over a large area by causing the shielding member of a required size to float at a required altitude. With this, it is possible to realize forecast and adjustment of an influence of warming and the like due to sunlight to natural environment. The effect of the present invention is to prevent the warming itself from occurring by shielding the sunlight using such as the light shielding device.

Further, in order to cast a shadow without altering an air flow to a large extent while preventing the global warming, it is necessary to cast a shadow on the Earth so as to prevent the shielding member from heating the atmosphere. According to the present invention, in a case in which a shadow is cast, it is possible to reflect and radiate sunlight energy into the space at a high altitude no lower than 100 m above the ground, and to prevent the sunlight energy from being converted into heat energy and radiated into the air, thereby preventing the global warming.

Moreover, the Earth is always heated by the sunlight. The Earth is heated during daytime when the Earth receives the sunlight, and cooled during night. It is hot near the equator, and cold in the Antarctica. Furthermore, it is already known that the Earth is cooled by covering the Earth by clouds to reflect the sunlight out of the Earth. By installing the light shielding device according to the present invention as an artificial reflection mechanism, for example, in the air (no lower than 10 km, for example) near the equator to radiate the sunlight out of the Earth to the space, the Earth is cooled. The surface of the light shielding device is painted in a metallic color, for example, and the sunlight is reflected toward the space. In order to lower an average temperature by about 1 degree centigrade by using a number of light shielding devices, an amount of the reflected sunlight is set such that a total area thereof is from on the order of 0.01% to 1% of an area of the Earth that always receives the sunlight. An optimal value can be set by confirming in simulations and experimentations.

The light shielding device is large, and provided with a float function by a buoyant force imparting unit, a sunlight shield function by a shielding member, and a movement function by a drive mechanism. Characteristics of the functions are such that, for example, the float function is configured to cause the device to float as a disc-shaped balloon by filling helium, and configured by an outer skin such as vinyl of 100 g/m², the sunlight shield function is configured to reflect and radiate sunlight into the space, and the movement function is configured to move the device by electric propellers, and to be remotely controlled by position measurement and a communication function based on a GPS function.

For example, a surface area of the Earth is 5.1×10⁸ and about at least 1,600,000 disc-shaped light shielding devices whose diameter is 1000 m is necessary in order to cast a shadow over 1% of the surface to prevent the warming. This means that energy of about 1.3×10¹² kilowatt-hour is constantly radiated out of the Earth every hour, and corresponds to a state in which the energy equals to electric power generated by about 1,300,000 nuclear generators is constantly removed to cool the Earth.

Using the light shielding device according to the present invention, it is possible to reduce the sunlight received by the Earth, and thereby immediately cooling the Earth. Even if the cooling by the present invention becomes unnecessary in the future, it is possible to terminate the cooling only by bringing the light shielding device down to the ground. In an operation according to the present invention, no CO₂ is emitted, and no energy is necessary for operation.

As a rough indication of an amount of the gas lighter than the air filled in the buoyant members, it is possible to realize stable floating in the direction of own weight by filling the gas of an amount with which buoyant force produced in the light shielding device is substantially equals to its own weight at a target altitude for having the light shielding device float. If a slightly less amount of gas is filled, the buoyant members are not strained tightly with tension at the target altitude, but can be made strained tightly by moving the buoyant members upward using the drive mechanism. By contrast, it is possible to make the buoyant members hang down by lowering the buoyant members to an altitude no higher than a target position using the drive mechanism.

Further, the shielding member can be configured such that a polarization function for shielding a part of sunlight spectrums is provided, that a mirror surface is provided by evaporating aluminum metal having favorable reflection rate or simply attaching an aluminum foil to a surface of the shielding member at the Sun side to reflect substantially all the sunlight, or that the sunlight is partially absorbed or reflected by a portion colored by an arbitrary color including a metallic color such as silver.

Here, as defined in claim 7, when the sunlight is shielded by coloring a surface of the shielding member to partially absorb the sunlight, it is possible to warm gas in and outside the buoyant members since the absorbed sunlight energy is converted into heat at the shielding member. With this, it is also possible to increase a temperature of the gas within the buoyant members to increase the buoyant force.

Further, as defined in claims 5 and 6, by employing a configuration in which apart of the shielding member includes an opening or an opening having a valve function openable and closable only when wind and rain pass, it is possible to reduce an influence of wind and rain to the light shielding device (in particular, there is a case in which the wind blows vertically, in addition to horizontally, and it is possible to make the shielding member spreading horizontally insusceptible to large force). Moreover, it is possible to prevent the weight of the shielding member from increasing to a large extent even if rain, water drops, or snow is fall on the shielding member.

Furthermore, as defined in claim 10, by employing a configuration in which a lightweight and strong material such as plastic is used, it is possible to install and move the shielding member, in particular, whose width and length are over 50 meters and that is strained tightly with tension against the sunlight at a high altitude.

In addition, as defined in claims 11 and 12, by a function of moving and controlling the position of the shielding member, it is possible to move the shielding member along with the movement of the Sun, in order to cast a shadow over a certain area to shield sunlight while the shielding member is set at a high altitude. The shielding member is large, and it is effective to operate the shielding member without bringing down to the ground for an extended period of time once the shielding member is set.

### BRIEF DESCRIPTION OF DRAWINGS

FIG. 1 is a block diagram showing a general idea of an entire light shielding device according to the present invention.

FIG. 2(a) and FIG. 2(b) are schematic illustration of shielding by a shielding member 11 shown in FIG. 1.

FIG. 3 is an illustration of a function for charging and discharging helium gas within a float function unit 61 as one example of a buoyant member 41 shown in FIG. 1.

FIG. 4 is an illustration of a light shielding device 80 in which a plurality of internal atmospheric pressures are set for the buoyant member 41 shown in FIG. 1.

FIG. 5(a) is a side elevational view of a light shielding device 91 provided with one example of a rotating unit 23 shown in FIG. 1, and FIG. 5(b) is a plan view of the same.

FIG. 6 is a side elevational view of a light shielding device according to a first embodiment of the present invention.

FIG. 7 is a plan view of the light shielding device according to the first embodiment of the present invention.

FIG. 8 is a side elevational view of a light shielding device according to a second embodiment of the present invention.

FIG. 9 is a plan view of the light shielding device according to the second embodiment of the present invention.

FIG. 10 is a side elevational view of the light shielding device according to the second embodiment of the present invention, when the light shielding device is folded.

FIG. 11 is a plan view of the light shielding device according to the second embodiment of the present invention, when the light shielding device is folded.

### DESCRIPTION OF EMBODIMENTS

The following describes embodiments of the present invention.

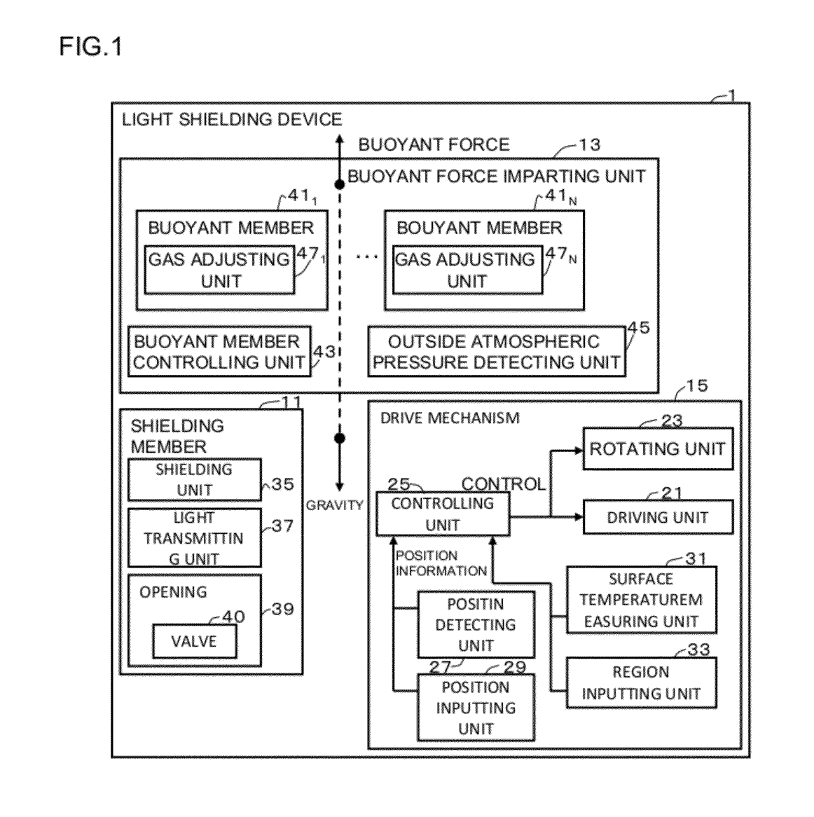

FIG. 1 is a block diagram illustrating a major configuration of a light shielding device according to the present invention. First, the major configuration of the light shielding device according to the present invention is described with reference to FIG. 1.

A light shielding device 1 is provided with a shielding member 11 configured to shield a spectrum of sunlight, a buoyant force imparting unit 13 configured to impart buoyant force to the shielding member 11 in a direction opposite of an own weight of the shielding member 11, and a drive mechanism 15 configured to move the light shielding device 1. In this case, if a component such as the buoyant force imparting unit 13 or the drive mechanism 15 needs electric energy in operation, the electric energy is supplied by configuring a part of the shielding member 11 as a solar cell to generate electric power and providing a power storage unit for the corresponding component to charge.

The drive mechanism 15 includes a driving unit 21 configured to move the light shielding device 1, a rotating unit 23 configured to rotate the light shielding device 1, a controlling unit 25 configured to control the driving unit 21 and the rotating unit 23, a position detecting unit 27 configured to detect a position of the light shielding device 1 using such as a GPS and to detect an altitude of the light shielding device 1, a position inputting unit 29 configured to input a position after the movement, a surface temperature measuring unit 31 configured to measure a surface temperature on the Earth, and a region inputting unit 33 configured to input a target area to be shielded. The controlling unit 25 uses an output of the detection by the position detecting unit 27 to make the shielding member 11 move to a position inputted by the position inputting unit 29, move to and settle at the position inputted by the position inputting unit, or settle at the position inputted by the position inputting unit without moving. Further, the controlling unit 25 moves the light shielding device 1 based on the surface temperature on the Earth measured by the surface temperature measuring unit 31 and information regarding the target area.

The surface temperature measuring unit 31 detects some areas to be cooled out of areas at which the temperature on the ground are the highest based on, for example, an image for temperatures measured on the ground using an infrared camera, or on data of the current and forecasted weather of the day and hour obtained from Meteorological Agency or other institutes. When there are a plurality of light shielding devices 1, the controlling unit 25 of one of the light shielding devices 1 that can be most easily-transferred to the area to be cooled takes the movement of the Sun into account and moves the corresponding light shielding devices 1 to a position at which a shadow can be cast on the area to be cooled.

It should be noted that, for example, it is possible to employ a configuration in which each of the light shielding devices 1 transmits an image for measured temperatures to a ground station, the movement of the plurality of light shielding devices 1 are adjusted at the ground station, the adjustment result is transmitted to the region inputting unit 33 of each of the light shielding devices 1, and each controlling unit 25 controls to shield the corresponding section to be cooled. Further, each light shielding device can be provided with a communication network device having a communication network function. For example, it is desirable to increase electric power of the wireless radiowave in a common wireless LAN so that wireless radiowave reaches within a range of about 40 km. This functions like a satellite-based mobile telephone system, but is provided with a communication network function instead of a satellite. Using the light shielding device 1 thus configured, it is possible to establish an economic communication network. Here, the electric power of the wireless radiowave is increased so as to reach within, but not limited to, a range of about 40 km.

The shielding member 11 has a function of reflecting and radiating a part or all of sunlight to itself toward a cosmic space at a high altitude no lower than 100 m above the ground, and includes, in order to shield a part or all of spectrums of sunlight, a light shielding unit 35 configured to shield the part or all of spectrums of sunlight, a light transmitting unit 37 configured to, when the light shielding unit 35 let a part of the spectrums of sunlight pass therethrough, allow passing of a part of the spectrums of sunlight, and an opening 39 configured to allow passing of wind and/or dropping of water through toward the ground. The opening 39 includes a valve 40, which opens in a case in which wind passes and/or water drops through toward the ground. The shielding member 11 is configured in a form of a film, and made of a plastic material, for example, so as to save weight.

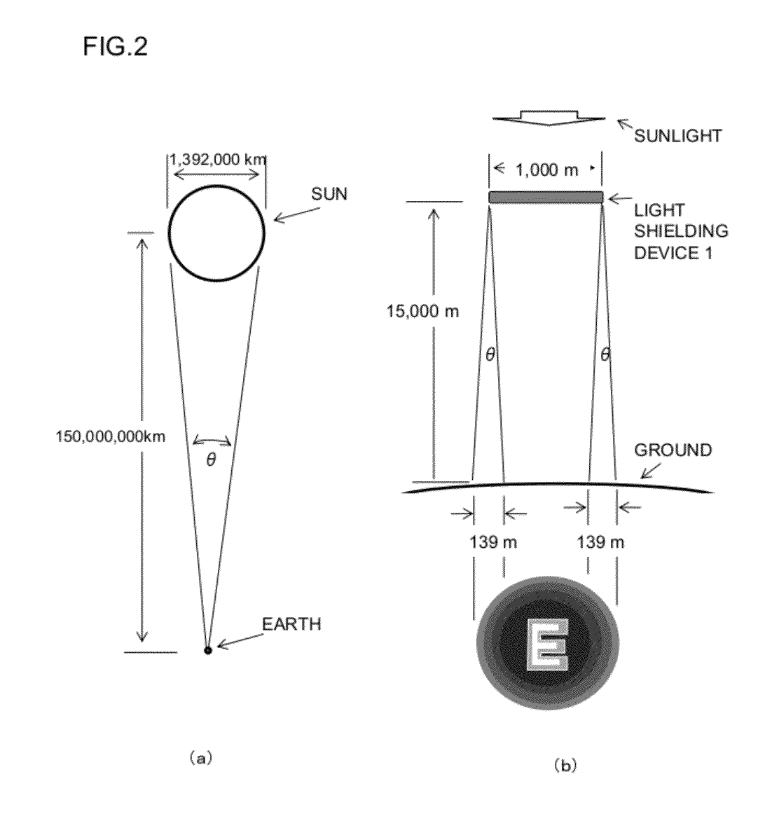

The shielding by the shielding member 11 is described with reference to FIG. 2. The diameter of the Sun is significantly large in consideration of the distance between the Earth and the Sun. Therefore, as shown in FIG. 2 (a), light beams from opposite sides of the Sun are not parallel and form an angle θ when the light reaches the ground. The angle of the light beams from the right and left ends of the Sun is on the order of 0.53 degrees. FIG. 2 (b) shows an image of a shape of a shadow on the ground cast by the light shielding device 1 when taking the angle into account. Due to the angle, a peripheral portion in the shadow of the light shielding device on the ground is thin. For example, when a letter “E” is drawn in the center of the light shielding device 1 and the light is transmitted through the portion of the letter, the letter is blurred with a thin shadow around a peripheral portion of the letter. The letter can be a different letter, a symbol, a logo or the like.

A person becomes temporarily blinded when it suddenly grows dark, and this is dangerous for the person. It is particularly dangerous to go suddenly under the shadow while driving a car. However, if a person goes under the shadow from the portion where the shadow is thin, and then moves under the actual shadow after driving about 100 m or more, the person gradually adjusts to the darkness and can drive more safely. It is possible to secure the safety by setting a sunlight shielding ratio of the portion between an edge of the light shielding device 1 and a portion 100 m to the center from the edge to be on the order of 90% so that it does not suddenly grow dark even when a person goes under the shadow of the light shielding device 1. In addition, it is possible to set the portion of the actual shadow to transmit sunlight of on the order of 5% or 1% instead of reflecting and radiating 100% of sunlight toward the space, so that it is not too dark for human eyes even when a person goes under the portion of the actual shadow.

As examples of meteorological changes, tornadoes and typhoons are produced due to heat locally produced in an area. Therefore, using a large number of light shielding devices 1 to cast shadows over the area on the order of 5% temporally on average lowers the temperature by about 3.5 degrees centigrade, and thus it is expected to suppress the generation of tornadoes and typhoons. It should be noted that if ineffective, casting shadows by 10% lowers the temperature even by about 7 degrees centigrade.

The shielding member 11 may be colored on a part or all of its surface to reflect and radiate sunlight to the space, or to absorb and shield sunlight, and can be configured to increase the temperature of gas lighter than air in buoyant members by converting the absorbed sunlight energy into heat.

The buoyant force imparting unit 13 includes a plurality of buoyant members 41₁, . . . , 41_{N} provided for the light shielding device 1 in a distributed manner and each filled with the gas lighter than air (hereinafter, referred basically to as, for example, “the plurality of buoyant members 41” by omitting indices when referring to the plurality of members), and a buoyant member controlling unit 43 configured to balance between each buoyant member 41 and own weight of a main body of the light shielding device 1, and to maintain the shielding member 11 and an object that is engaged with the shielding member 11 in a floating state in which the shielding member 11 and the object are in a non-contact state with a surface of the ground. Each of the buoyant members 41 includes a gas adjusting unit 47 configured to individually adjust an amount of the gas lighter than the air filled into the corresponding buoyant member 41. The following describes the gas adjusting unit 47 using a pump (including a gas cylinder) for adjusting an amount of the gas. Buoyant force is produced by the buoyant members 41, and imparted to the light shielding device 1 in a direction opposite of the gravity due to the own weight of the main body. A magnitude of the buoyant force produced by the buoyant members 41 depends on a magnitude of gravity acting on the gas that is pushed aside by the buoyant members 41, and it is possible to cause the light shielding device 1 to float.

A vector of the buoyant force and a vector of the own weight due to gravity are in the opposite directions, and it is preferable that a starting point of the vector of the buoyant force is positioned above a starting point of the vector of the own weight in terms of keeping the main body of the device horizontally.

Further, it is preferable that a part or all of the buoyant members 41 constitute the main body of the light shielding device 1, and an internal pressure of the gas lighter than the air in each of the buoyant members 41 is higher than an outside atmospheric pressure at a predetermined altitude, thereby maintaining a strength for keeping a shape at this altitude.

Moreover, the strength for keeping the shape can also be maintained by a mechanism configured to pull the main body of the light shielding device 1 outwardly by centrifugal force produced by the rotating unit 23 causing the light shielding device 1 to rotate. Furthermore, the buoyant members 41 can be such that an inner surface of a lower section, instead of an outer surface of an upper section, of the buoyant members 41 is colored, and the temperature of the gas lighter than the air can also be increased by the sunlight energy absorbed by the colored portion.

Further, the buoyant force imparting unit 13 is provided with an outside atmospheric pressure detecting unit 45 configured to detect the outside atmospheric pressure at the position at which the light shielding device 1 is present. Each pump can be configured to adjust the internal pressure of the gas lighter than the air in the corresponding buoyant member 41 to be higher than the outside atmospheric pressure at the position at which the light shielding device 1 shields the light.

Moreover, the shielding member 11 of the light shielding device 1 can be configured integrally with or separately from the buoyant force imparting unit 13. The buoyant force imparting unit 13 cannot be used if helium gas leaks even through a small hole in a cell due to damage. When the shielding member 11 is damaged and a large hole is formed, only the reflection function and the sunlight shield function of the damaged portion cannot be used, and there is no problem as the shielding member other than that the shadow cast by the shielding member becomes slightly smaller. Therefore, it is possible to configure the light shielding device by metallic painting over thin cloth, for example, so as to reflect the sunlight as well as to save weight of the light shielding controlling device.

Next, the balance between the components is specifically described taking characteristics of a float function of a tube (bag) in which helium gas is filled into configured by a soft film as an example. Here, a volume represents a size of a vessel, and a content represents an amount contained in the vessel. Here, the tube is soft, but its volume does not change. It should be noted that while a plastic film is assumed as the soft film to enclose helium gas in this case, any soft and lightweight film can be used as long as it does not allow gas such as helium gas to pass through at about −70 degrees centigrade. In addition, while the example in which helium gas is used as the gas to be filled is described, the air can be filled separately from the float function.

An external environment condition of the shielding device 1 largely differs depending on its field of application. The field of application is classified according to an altitude to be installed, into installation in the stratosphere no lower than about 10 km and installation at an altitude no higher than about 10 km. In the stratosphere, the temperature might be no lower than about −70 degrees centigrade, the atmospheric pressure might be no higher than about 0.1 atmosphere, and there is slight breeze but no rain. By contrast, at the altitude no higher than 10 km, the temperature is from about −70 degrees centigrade to 50 degrees centigrade, the atmospheric pressure is from about 0.1 to 1 atmosphere, and rain and wind are hard.

Further, the shielding device 1 is a large device, whose width and length in some cases are no smaller than 100 m. It is necessary to move and install the shielding device 1 at an appropriate position at high altitudes including the stratosphere for an extended period of time over a year, and therefore it is desirable to save the weight.

As the tube performing the float function, it is possible to consider a type whose volume of helium gas changes as the atmospheric pressure changes, and a type whose volume of helium gas does not change even when the atmospheric pressure changes. If there are a difference between the outside atmospheric pressure and an internal atmospheric pressure of the tube, a pressure corresponding to the difference between the atmospheric pressures is applied to the material of the tube.

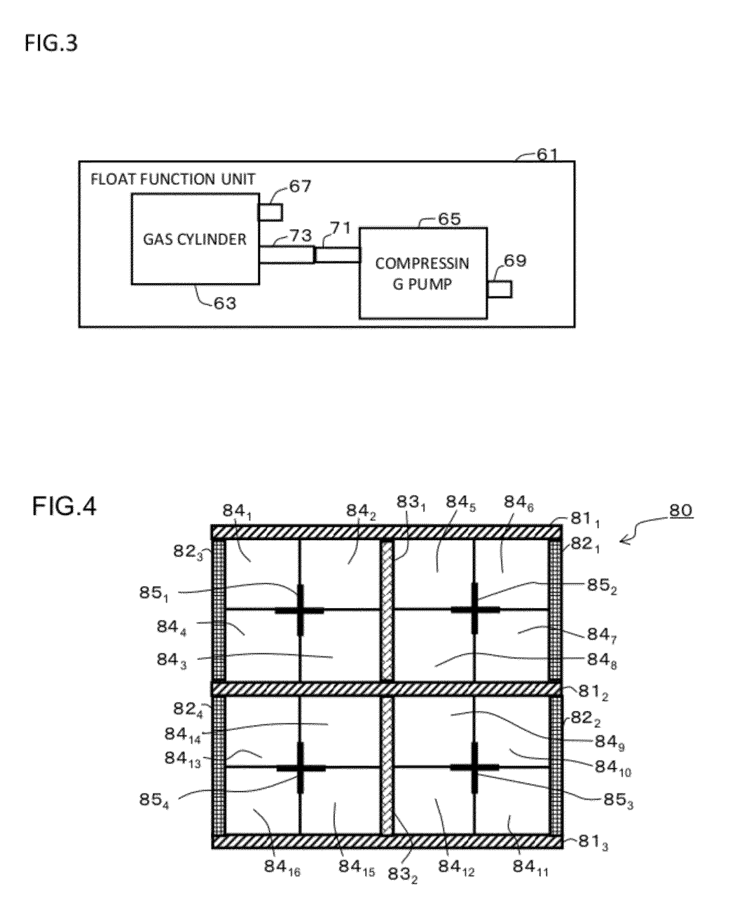

First, the tube of the type whose volume of helium gas changes as the atmospheric pressure changes is specifically described as one example of the configurations of the buoyant member 41 and the buoyant member controlling unit 43 with reference to FIG. 3. FIG. 3 is an illustration of a function for charging and discharging helium gas within a float function unit 61 which works as the buoyant member 41 and the buoyant member controlling unit 43 shown in FIG. 1.

The float function unit 61 includes a gas cylinder 63 that stores compressed helium gas therein and a compressing pump 65 that performs the gas compression. The gas cylinder 63 is provided, at its outlet, with a function of measuring the atmospheric pressure of gas to be emitted, and it is possible to measure an amount of the gas in the cylinder indirectly based on a value of the pressure of the gas. The gas cylinder 63 and the compressing pump 65 are also provided with a function of receiving and transmitting a wireless signal from and to a control function unit that is not depicted, and the gas cylinder 65 can receive and transmit a wireless signal including the value of the amount of the gas from and to the control function unit. For the wireless communication function, for the wireless communication function by the wireless signal, and for an open-close control function such as a discharge valve 67, the conventional technique can be used.

In a case in which helium gas is discharged into the float function unit 61 in order to increase the buoyant force of the light shielding device, the gas cylinder 63 receives a wireless signal from the control function unit, and opens the discharge valve 67 for the gas to discharge helium gas until the amount of the gas within the gas cylinder 63 reaches the value instructed by the control function unit.

By contrast, in a case in which helium gas is removed from buoyant function unit 61 and filled into the gas cylinder 63 in order to reduce the buoyant force of the light shielding device, the compressing pump 65 receives a wireless signal from the control function unit, inputs helium gas within the buoyant function unit 61 through an inlet 69 to compress the inputted gas based on the received signal, and discharges the compressed helium gas through an outlet 71 and injects through an inlet 73 of the gas cylinder 63 until the amount of the gas within the gas cylinder 63 reaches the value instructed by the control function unit.

Next, the tube of the type whose volume of helium gas does not change is described. A framework of the light shielding device 1 is formed using a material with which the shape of the light shielding device 1 can be stably formed, for example, such as a plastic film enclosing air or helium gas and impermeable to gas. An amount of enclosed helium gas is set to be such that a content equivalent to the volume of 0.1 times of a volume of the framework at 1 atmospheric pressure. The tube on the ground under 1 atmospheric pressure expands only one tenth of the volume. The light shielding device 1 on the ground under 1 atmospheric pressure is soft in the framework, and does not take an expanded form.

At an altitude of about 12 km above the ground, the atmospheric pressure reduces down to 0.1 atmospheric pressure, and the helium gas spreads out in the tube, and the tube is spread and strained tightly. The buoyant force in this case is a weight of external air of the volume equals to the volume of the tube under the outside atmospheric pressure. Specifically, under 1 atmospheric pressure, the volume of the helium gas within the tube is 0.1 times of W, and if the atmospheric pressure reduces, the volume of the helium gas increases. Under 0.1 atmospheric pressure, the volume of the helium gas is 1 times of W, and the buoyant force does not change and is constant at an altitude at which the external air is from 1 atmospheric pressure to 0.1 atmospheric pressure. Therefore, the outside atmospheric pressure and the internal atmospheric pressure of the tube are equal, and no atmospheric pressure is imparted to the material of the tube. Accordingly, in the stratosphere where the atmospheric pressure is no higher than 0.1 atmospheric pressure, the atmospheric pressure within the framework becomes higher than the outside atmospheric pressure, and the framework is strained tightly with tension, providing the framework with firmness, thereby extending the light shielding device 1.

More specifically, helium gas of the content corresponding to one tenth of the volume of the tube under 1 atmospheric pressure (assuming that the volume is W m³) is filled. The own weight of the tube as a whole including the helium gas is expressed as R g. The buoyant force in the atmosphere of 1 atmospheric pressure on the ground at this time is the weight of the air whose volume is equal to that of the helium gas, which is ρW/10. Here, ρ is a density of the air of 1 m³ under 1 atmospheric pressure.

The tube rises in the air when ρW/10 is larger than the own weight R, and when reaching the altitude of about 0.1 atmospheric pressure, the helium gas spreads out within the volume of the tube, the volume becomes W and the density of the air at this time becomes ρ/10, and thus the buoyant force is ρW/10. In other words, the buoyant force does not change according to the altitude up to this altitude. When the tube rises higher than the altitude of about 0.1 atmospheric pressure, the atmospheric pressure becomes lower than 0.1 atmospheric pressure, but the volume of the helium cannot increase more than the volume of the tube, and therefore the buoyant force decreases. The tube stops rising at an altitude L m, where the buoyant force is equal to R g, and stays at this altitude unless the tube is moved upward by the movement function. Therefore, it is possible to operate in a manner such that helium is inputted into a part of the tubes to an extent such that the tubes are not strained tightly with tension unless the tube is moved upward by the movement function, that all the tubes are strained tightly with tension by moving upward using the movement function when casting a shadow, and that a part of the tubes are folded without being strained tightly with tension by not moving upward using the movement function when it is unnecessary to cast a shadow.

Here, as for the altitudes at which the volume of the helium gas reaches constant, it is possible to design the light shielding device whose volume of the helium gas reaches constant at any particular gas pressure. Further, as for design accuracy in relation to the helium gas, it is possible to adjust the content of helium gas with an error no greater than 1%, and it is possible to obtain the buoyant force with an error no greater than 1% by filling the gas as designed. In addition, it is possible to easily realize the shielding member and the buoyant members with an error no greater than 1% by configuring its area as designed. For example, if processing such as cutting and bonding can be performed with precision of 1 mm, it is possible to design a device no smaller than 10 m with precision of 0.1%. Therefore, once a target altitude of an installation position is determined, the content constituted by the buoyant members and the gas content to be filled are determined, which can be realized with precision of about 1%, and thus it is possible to balance the buoyant force with the own weight with precision of about 1% only by the design. In actual operation, about 1% of error between the buoyant force and the own weight only slightly changes the altitude at which the light shielding device 1 floats.

Moreover, for a light shielding device configured by a plurality of floating members, even if there is an error of about 1% between buoyant force and own weight of the plurality of floating members, there is no substantial influence to stability of a posture of the device other than that a degree of expansion of the light shielding device in a vertical direction is somewhat different, which is caused by the floating members having larger buoyant force and smaller buoyant force.

Furthermore, when the content of the helium gas filled into the tube increases by a few %, the volume of the helium gas stops expanding over W and becomes constant at an altitude higher than the altitude of 0.1 atmospheric pressure but lower than L m, the mass of the entire tube increases by an amount of the helium gas additionally filled, and therefore the altitude at which the tube stays becomes lower. Further, when the volume of the helium gas becomes constant without being able to expand over W, the surface of the tube strained tightly with tension can be used as the framework that forms an entire device. In this manner, the errors in the content of the helium gas that is filled and the volume of the tubes only affect the altitude at which the tubes stay floating, and does not affect floating stability of the tubes. Moreover, when the altitude at which the light shielding device 1 stays floating is designed as from 10 km to 50 km, the device may not be damaged or the shadow may not become significantly smaller even though the shape of the shadow varies by a few % due to the error of the altitude by a few % from the design value, and the operation may not be affected.

Therefore, the buoyant force and the own weight of the plurality of buoyant members configured as designed can balance with an error no greater than 1%. Furthermore, installing the light shielding device 1 with an inclination of 1 to 10 degrees or less slightly reduces an area of the shadow cast on the surface of the ground, but this does not make the device inoperable. That is, even if the balancing ratio varies by 1% or more, the device will not be inclined to such a large extent that the device cannot be used.

Density of the air changes according to the altitude at which the light shielding device 1 floats, and thus the buoyant force imparted to the light shielding device 1 changes. From 0 km to 50 km above the ground, the density of the air changes from about 1 to 0.001 as the altitude increases. Therefore, for example, when a light shielding device whose diameter is 1 km is inclined by about 6 degrees, a difference between the altitudes on the both sides of the device is 100 m, and large force to level the inclination acts since the buoyant force on either side varies about 1.4%. Accordingly, when the device is inclined to a large extent, for example, by 10 degrees, the buoyant force changes largely due to the change in the density of the air depending on the altitude, the buoyant force acts to level the inclination, and the device is restored, installed, and operated at a stable posture.

Further, in a case in which the operation is for preventing warming in a specific area, it is not necessary to cast a shadow only over a specific small area (an area of 1 km square, for example), as long as the shadow is cast within a large region including the specific small area (an area of 10 km square, for example). In this case, the light shielding device may be installed at one position on a windward side in the large region considering the direction of the sunlight, and when the device is drifted to the other side of the region by wind, the device may be again moved to the windward side using the movement function. During the movement, even if the posture of the light shielding device is somewhat undesirable, this is not a problem since this does not damage the light shielding device or objects on the ground. Further, it is not necessary to control the posture of the light shielding device with maximum reflection efficiency to cast a shadow on the ground, and it is possible to operate with an inclination on the order of 5 degrees.

It should be noted that a framework having a tension at any atmospheric pressure from 1 atmospheric pressure to 0.1 atmospheric pressure can be used together. For example, in the framework into which helium gas of the content corresponding to the volume of the tube under 1 atmospheric pressure (volume is Wm³) is filled, the entire tube expands on the ground under 1 atmospheric pressure, and the tube is spread and strained tightly. If the atmospheric pressure becomes 0.1 atmospheric pressure, the tube remains spread and strained tightly since the volume of the tube has no margin to expand. In this case, the volume is constant at W under 1 atmospheric pressure and under 0.1 atmospheric pressure, and since the volume is 1 times of W even if the external air changes from 1 atmospheric pressure to 0.1 atmospheric pressure, or under 0.1 atmospheric pressure. Therefore, the buoyant force reduces from 1 times to 0.1 times of the buoyant force on the ground under 1 atmospheric pressure as the external air changes from 1 atmospheric pressure to 0.1 atmospheric pressure.

Further, for example, it is possible to prepare a plurality of types of frameworks that can provide tensions at different atmospheric pressures using this phenomenon so that the framework is sequentially formed and gradually spread as the atmospheric pressure reduces when the light shielding device 1 that is softly folded on the ground rises in the air. Specifically, by setting a plurality of internal pressures for the buoyant members forming the framework of the light shielding device 1, it is possible to form the framework of the light shielding device 1 sequentially at the set altitudes while the light shielding device 1 rises upward. For example, it is possible to form a first framework at an altitude under 0.5 atmospheric pressure, a second framework at an altitude under 0.4 atmospheric pressure, a third framework at an altitude under 0.3 atmospheric pressure, and a fourth framework at an altitude under 0.2 atmospheric pressure. In this manner, when installing the light shielding device 1, the light shielding device 1 is folded up small on the ground, the framework is automatically formed as the atmospheric pressure decreases as the altitude becomes higher, and spreads out wide by sequentially forming the frameworks. This advantageously facilitates maintenance management of the light shielding device 1 on the ground. Further, this requires only a small work area on the ground. Moreover, it is possible to suppress damages such as an error in an installation place due to wind and rain, since an area and a cubic volume of the light shielding device 1 are small. The atmospheric pressure formed by the framework can be set to be any atmospheric pressure as long as no higher than 1 atmospheric pressure.

FIG. 4 is an illustration of a light shielding device 80 in which the plurality of internal atmospheric pressures are set for the buoyant members 41 shown in FIG. 1. An entire own weight of the light shielding device 80 is assumed to be W. The buoyant members for which three types of internal pressures are set are used. As described above, buoyant force can be obtained by a cubic volume of the gas pushed aside, and each floating member is strained tightly at a predetermined atmospheric pressure by the amount of the gas filled thereto. Three buoyant members 81 of top, middle, and bottom, extending in a traverse direction have buoyant force of 4 W/24 at 0.1 atmospheric pressure, and strained tightly at 0.5 atmospheric pressure. Four buoyant members 82 that connect the buoyant members 81 on right and left ends have buoyant force of 2 W/24 at 0.1 atmospheric pressure, and strained tightly at 0.4 atmospheric pressure. Two buoyant members 83 that connect the buoyant members 81 in the center have buoyant force of 2 W/24 at 0.1 atmospheric pressure, and strained tightly at 0.2 atmospheric pressure. Further, a shielding member 84 is configured such that aluminum is evaporated on such as cloth and have the reflection function. Valves 85 are portions configured by making a cut in the shielding member 84 and connecting by a member having an expansion-contraction function such as rubber.

Due to a total of the buoyant force of the buoyant members 81, 82, and 83, the balance with the own weight is taken at an altitude of 0.1 atmospheric pressure, and each buoyant member is balanced individually by its own weight. The adjustment of the buoyant force is possible, in general, by equalizing the volume of the tube of the buoyant function unit with volume of the air under 0.1 atmospheric pressure corresponding to the own weight bore by the tube, and by inserting the volume of the helium into the tube enough to strain the tube tightly under the atmospheric pressure.

When installing the sunlight reflection controlling device thus designed at a high altitude, the device is folded up small on the ground. A portion of the device having the buoyant force is upside, and the shielding member 84 hangs downward. As the light shielding device 80 rises upward, the light shielding device 80 spreads out widely by first providing the tension for the buoyant members 81 at the altitude under 0.5 atmospheric pressure, providing the tension for the buoyant members 82 at the altitude under 0.4 atmospheric pressure, and finally providing the tension for the buoyant members 83 at the altitude under 0.1 atmospheric pressure to form the framework. In operation, by moving the device constantly upward by a movement function unit, and moving the device higher than 0.1 atmospheric pressure, it is possible to realize stable installation of the device in a state in which a part of the own weight of the device is held above the center of gravity in a state in which the part of the own weight is pulled upward by the movement function unit.

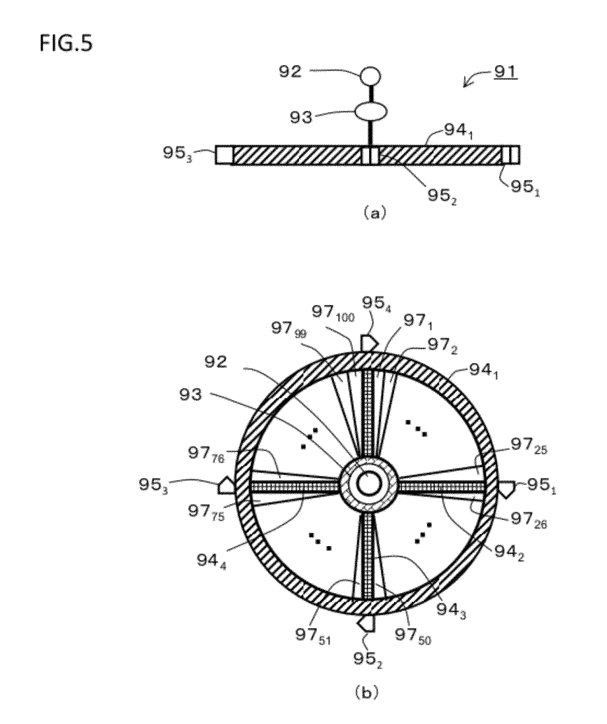

Further, stabilizing of the posture by the rotating unit 23 is specifically described with reference to FIG. 5. FIG. 5(a) is a side elevational view of a light shielding device 91 provided with one example of the rotating unit 23 shown in FIG. 1, and FIG. 5(b) is a plan view of the light shielding device 91. The light shielding device 91 includes a driving unit 92, a controlling unit 93, six floating members 94 constituting the framework, four propellers for rotation 95 configured to cause the light shielding device 91 to rotate about a central axis, and 100 floating members 97. The floating members 94 are configured with the tube filled with helium gas at a maximum under 1 atmospheric pressure. Each floating member 97 is configured by a tube filled with helium gas of content corresponding to 0.1 times of the volume of the tube at 1 atmospheric pressure.

Referring to FIG. 5(b), in order to maintain a state in which the huge light shielding device 91 is stably spread out in the stratosphere, the plurality of propellers 95 driven by electricity are disposed at point-symmetric points along an outer frame of the light shielding device 91. The electric energy for the propellers can be supplied using a solar energy generator disposed on a surface of the light shielding device 91. The propellers 95 are driven to rotate the light shielding device 91 in a certain direction, and the light shielding device 91 rotates horizontally like a spinning top. Its rotating speed depends on driving force of the propellers 95, but not required to be high. This rotation stably maintains the device horizontally, and when centrifugal force works, a strength to maintain the shape of the light shielding device 1 by pulling outwardly works.

This centrifugal force is such that each mass is pulled by a tension F expressed as follows and it is possible to maintain the stable shape, where an angular velocity is ω, a distance from a center of the light shielding device 1 is r, and a mass per unit volume of the light shielding device 1 is m assuming a tension mechanism is uniform. Here, r=1000 m, ω=π/180, and m=100 g.

$$\begin{matrix}F = r \times {ω}^{2} \times m \\ = 1000 \times {( π / 180 )}^{2} \times 100 \\ \approx 30.4\end{matrix} \qquad eq ( 1 )$$

By contrast, where a weight of the entire light shielding device 1 is M, and the device is configured by 100 parts, each part is imparted, at a central point, with centrifugal force G as expressed by eq (2). Here, R₁=600 m (distance between the center and a center of gravity of each part), ω=π/180, and M₁=(π×10⁶)/100 g.

$$\begin{matrix}G = {R}_{1} \times {ω}^{2} \times {M}_{1} \\ = 600 \times {( π / 180 )}^{2} \times ( π \times {10}^{6} ) / 100 \\ \approx 5710\end{matrix} \qquad eq ( 2 )$$

Thus, when the light shielding device 91 is about 3.14 ton and rotates at a speed of rotating once every 360 seconds, each of the 100 parts is imparted with centrifugal force of about 5710 g, with which the light shielding device 91 is spread out horizontally and installed stably. This centrifugal force increases as a radius increases and as a mass of the material of the light shielding device 91 increases, and reduces as the angular velocity decreases. Therefore, it is possible to maintain the centrifugal force to be an appropriate value by appropriately designing and implementing the angular velocity according to the configuration of the light shielding device 91.

A magnitude of the centrifugal force varies depending on wind strength, direction, and change at the position where the device is installed. When installing in the stratosphere, only steady wind blows and there is little onrushing wind. Further, this centrifugal force can be very small in a case of operation in which the shadow can be cast anywhere as long as the sunlight is reflected and radiated to the space to prevent the global warming and the device can be drifted on the wind, unlike the case of casting a shadow over the specific area. As described above, if the device inclines by 30 degrees, for example, the device is pushed by force of about 10% of the own weight to a restoring direction, and restores the horizontal posture. Therefore, once the light shielding device spreads out horizontally, the posture is maintained horizontally.

Moreover, by making the light shielding device 1 in a small size, for example, having a radius on the order of 100 m, and by increasing the centrifugal force, the device can immediately restore the horizontal posture even when onrushing wind blows. The speed for restoring the posture depends on the centrifugal force. This is a mechanism similar to a spinning top. Even if an edge of a spinning top is chipped off and gravity lacks balance by on the order of 5%, the spinning top rotates maintaining its rotational shaft vertically as long as the spinning top is rotating at a high speed. Even if more or less external force is imparted to the spinning top, its shaft restores the vertical posture once the force is resolved. Therefore, although the restoring force increases as the centrifugal force is larger, it is necessary to design the material of the device to be durable to the centrifugal force since the light shielding device is pulled by the centrifugal force when it rotates. In a safe design, the rotating speed should be set so that the centrifugal force is about half of the centrifugal force to which the light shielding device can endure.

Furthermore, with the rotation, the rotating unit 23 can spin, by centrifugal force, off the rain, snow, and dust disposed on the light shielding device 1 for some reason.

Further, the wind is a flow of a medium on which the light shielding device floats. When the light shielding device 1 is drifted on the wind, there is no major problem if the device is drifted on the wind, since the air is in a stationary condition when viewed from the light shielding device 1 and the posture of the device is restored to the horizontal posture according to the change in the density of the air if the device floats and moves on the wind. However, it requires a large force to cause the light shielding device 1 to stay against the wind when drifted on the wind. The operation should be carried out depending on characteristics of the season and time of the wind in the area in which the device is installed. If the wind is steady, it is possible to cause the device to stay against the wind by increasing the force caused by the driving unit 21 of the drive mechanism 15. However, especially when the light shielding device 1 is large, it is difficult to operate in an area where strong wind or onrushing wind whose wind speed is 10 m/s blows, for example. In this case, the device can be brought down to the ground when it is not possible to operate due to strong wind, and may be operated only when the wind becomes weaker. It is not necessary to operate the light shielding device 1 always in a specific time. It is desirable to operate the light shielding device easily referring to wind forecast. Therefore, the light shielding device 1 can be installed and operated against the wind in the area where steady wind blows or when wind is weak. Moving the light shielding device 1 against the wind possibly causes the light shielding device 1 to incline to a large extent, but an influence of this inclination to a size of the shadow is small.

It should be noted that, in order to rotate the light shielding device 1, instead of the electric propellers, for example, it is possible to provide a plurality of cup-shaped objects around the light shielding device so that a curved surface of each object is directed toward a direction of rotation, and to cause the rotation by wind force like a wind gauge. Further, the driving unit 21 (driving propeller for movement) and the rotating unit 23 (electric propeller for rotation) can be integrally configured.

Moreover, when realizing the float function of the light shielding device 1, it is possible to apply a plurality of configurations, and economically realize the configuration of the light shielding device 1 that does not fall on the ground even if a part of the float function is damaged. Here, as the tube that realizes the float function, an example in which the type whose volume of helium gas changes as the atmospheric pressure changes, and the type whose volume of helium gas does not change even when the atmospheric pressure changes are combined is specifically described.

A volume of the type of the tube whose volume of helium gas does not change as the atmospheric pressure changes (this type is referred to as T1) is taken as SW m³. Further, a volume of the type of the tube whose volume of helium gas changes as the atmospheric pressure changes from 0.1 atmospheric pressure to 1 atmospheric pressure (this type is referred to as T2) is taken as WW m³, and the volume of helium gas is taken as WW m³ at 0.1 atmospheric pressure. Moreover, an entire mass of the light shielding device 1 is taken as WG g. It is assumed that the buoyant force and the gravity are balanced at an altitude under 0.1 atmospheric pressure. Furthermore, the density of the air per 1 m3 under 1 atmospheric pressure is taken as p. At this time, since the buoyant force and the gravity are balanced under 0.1 atmospheric pressure, eq (3) holds. Further, eq (4) holds for the light shielding device under 1 atmospheric pressure on the ground, and the device rises, and stops and floats at an altitude where the external air is 0.1 atmospheric pressure. Here, by setting WW to be 9 times as large as SW, eq (5) and eq (6) hold. The buoyant force on the ground at this time is expressed by eq (7).

WG=0.1×ρ×WW+0.1×ρ×SW eq (3)

WG<ρ×0.1×WW+ρ×SW eq (4)

SW=WG/((0.9+0.1)×ρ)=WG/(ρ) eq (5)

WW=9×WG/(ρ) eq (6)

0.1×ρ×WW+ρ×SW=0.9WG+WG=1.9WG>WG eq (7)

As the light shielding device 1, the buoyant force and the own weight are balanced on the ground as long as the buoyant force of 0.9 WG is maintained. Further, it can be seen that the balance is maintained even if T1 is damaged and 90% of the helium gas is released, or even if T2 is damaged and all of the helium gas is released. Specifically, it is possible to prevent the device from falling even if about 45% of the entire buoyant function of the light shielding device is damaged and lost. The content of the helium gas required at this time is (0.1×WW+SW)=1.9×WG/(ρ) under 1 atmospheric pressure. By contrast, WG=0.1×ρ×SW when the device is configured only by the configuration of T1, and the content of the helium gas required is SW=10×WG/(ρ) under 1 atmospheric pressure, which is 5 times as large as the content of the helium gas. Therefore, the configuration of using both T1 and T2 needs considerably less content of helium gas and is more economical than the case of the configuration of only using T1.

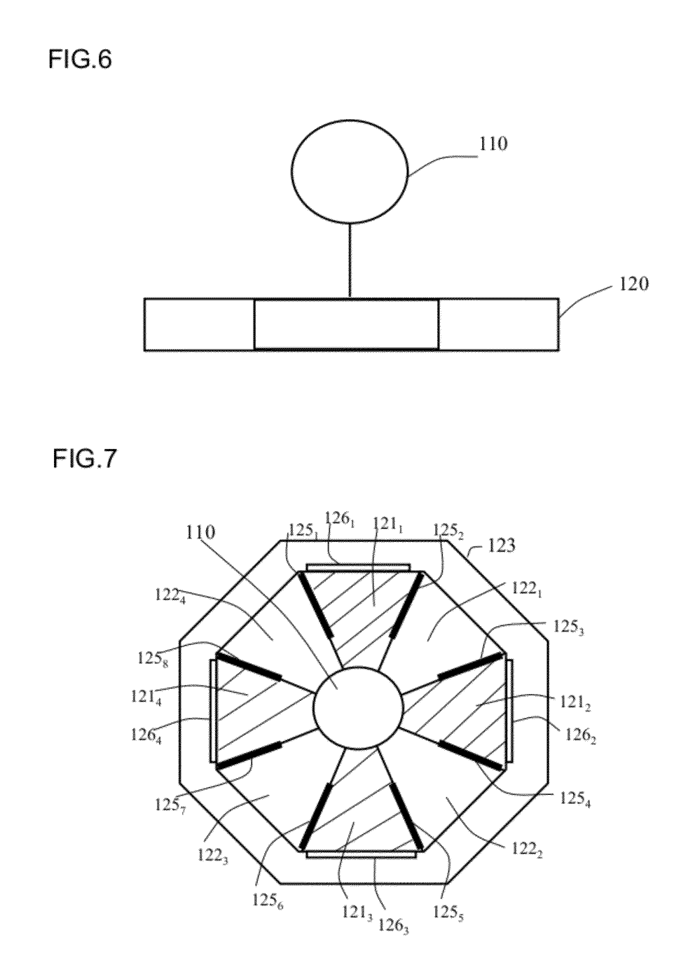

In the following, the light shielding device according to the present invention is specifically described with reference to FIG. 6 and after. It should be noted that an embodiment of the present invention are not limited to embodiments described below.

### Embodiment 1

FIG. 6 shows the light shielding device according to an embodiment 1 of the present invention viewed from its side, and FIG. 7 shows this light shielding device viewed from its top. The following describes the embodiment 1 with reference to FIG. 6 and FIG. 7.

Referring to FIG. 6, the light shielding device includes a buoyant member 110, and a shielding member 120. Referring to FIG. 7, the shielding member 120 is configured by a light shielding unit 121, and a light transmitting unit 122. The light shielding unit 121 has an aluminum foil on its surface facing toward the Sun, and reflects sunlight to cast a shadow. The light transmitting unit 122 is made of transparent vinyl, and configured as a sunlight transmitting unit that transmits the sunlight. It should be noted that the gas lighter than the air such as helium is filled within the shielding member 120.

Further, as shown in FIG. 7, the light shielding device is provided with buoyant member 123 in which the air on the surface of the ground or the gas lighter than the air such as helium is filled as an outer circumference unit of the main body along an outer circumference of the shielding member 120. It is possible to fill gas into the outer circumference unit so that the unit is strained tightly with tension, and to expand the outer circumference unit at a predetermined altitude. At this time, the shielding member 120 is imparted with tension of the outer circumference unit, and the shielding member 120 is spread by being pulled from the circumference. With this, an area of the shielding member for shielding is secured, and therefore the light shielding device 1 can effectively shield the light.

Further, by configuring to produce the buoyant force on a side of the outer circumference of the shielding member 120, it is possible to expect an effect that the light shielding device 1 can be easily balanced with respect to the rotation as described below. When the light shielding device 1 is inclined with respect to a horizontal plane, an end that has risen upward due to the inclination is pulled downward since its position is high, the air density is low so that the buoyant force is smaller than that at a normal position. Further, an end that has lowered due to the inclination is pulled upward, as its position is low, the air density is high so that the buoyant force is greater than that at the normal position. In this manner, the light shielding device 1 has a nature that it is stable with respect to the horizontal plane, and this nature is more notable as more buoyant force is produced near the end of the shielding member 120.

The buoyant member 110 is configured by a tube made of vinyl in which the gas lighter than the air such as helium gas is filled, and is able to impart buoyant force in a direction opposite of the own weight of the light shielding device 1 provided with the shielding member 120. By configuring the buoyant member 110 to have a sufficient volume, it is possible to produce buoyant force for stabilizing the shielding member 120 and the buoyant member 123 engaged with the shielding member 120 in the air floating at a targeted altitude. Here, the case in which the vinyl tube is used is described, the material can be any lightweight and soft material that is impermeable to gas such as other plastic or rubber.

Further, when the light shielding device is installed under clouds, the light shielding device sways to a large extent due to wind and rain. Therefore, as shown in FIG. 7, the shielding member 120 is provided with openings 125 (holes) and valves 126 in openings so that a resistance of the light shielding device against the wind and rain in a vertical direction is made smaller. The openings 125 are portions provided as cut lines separable between the light shielding unit 121 and the light transmitting unit 122. And the valves 126 are configured by providing cut lines between the light shielding unit 121 and the buoyant member 123 and connecting the light shielding unit 121 and the buoyant member 123 with soft and extensible material (rubber or springs, for example). With this, the valves 126 are configured so that the light shielding unit 121 is separated from the light transmitting unit 123 when strong wind blows, and the light shielding unit 121 and the light transmitting unit 123 return to an original position when the wind ceases, thereby realizing a function of the valve that opens and closes against the wind and rain if necessary. The valves 126 are not required to be completely closed even when the wind and rain are weak, or to shield 100% of the sunlight, and therefore the shadow casting function is effective enough even if a valve 126 involves an opening of a constant width similarly to the openings 125.

In this case, the shielding member 120 also serves as a buoyant member. In addition, the buoyant force produced by the buoyant member 110 and the buoyant member 123 are balanced with the own weight of the light shielding device 1 as a whole. However, it is possible to employ a configuration in which, considering that the shielding member 120 does not produce any buoyant force, for example, as well as that the buoyant member 123 is not necessary, the own weight of the light shielding device 1 as a whole (main body) is balanced only with the buoyant force of the buoyant member 110. Alternatively, it is possible to employ a configuration in which, considering that the buoyant member 110 is not necessary, the own weight of the light shielding device 1 as a whole (main body) is balanced only with the buoyant force of the buoyant member 123. Specifically, it is sufficient as long as the light shielding device 1 is maintained horizontally, and therefore it is necessary to employ a configuration in which the own weight due to gravity is balanced with the buoyant force at each portion.

### Embodiment 2

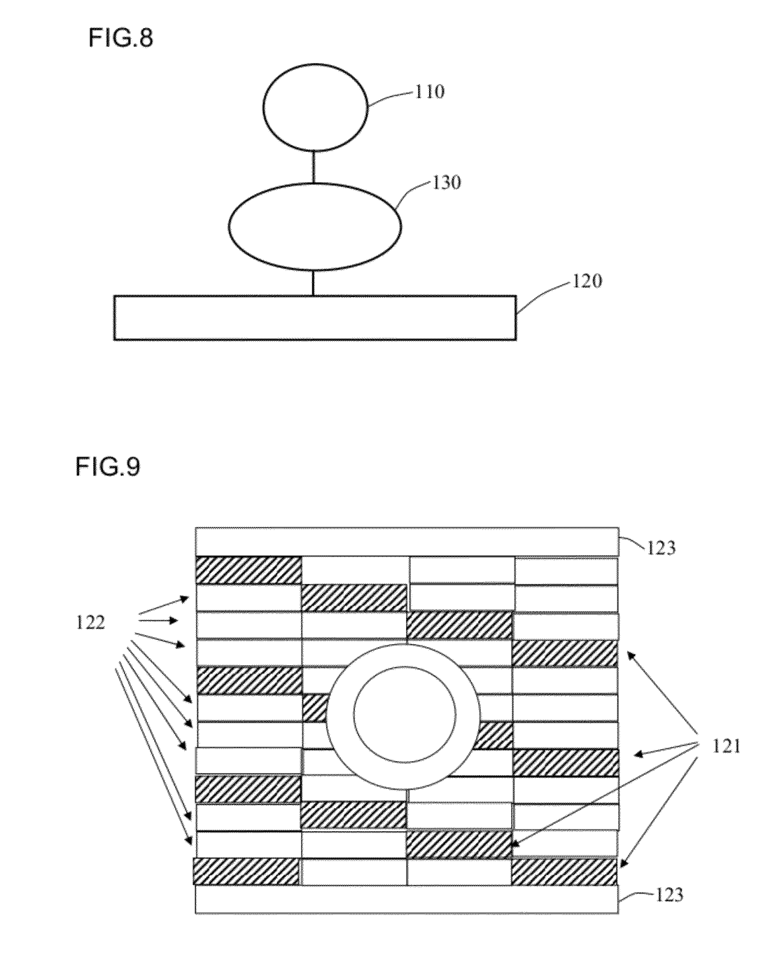

FIG. 8 shows the light shielding device according to an embodiment 2 of the present invention viewed from its side, and FIG. 9 shows this light shielding device viewed from its top. The following describes the embodiment 2 with reference to FIG. 8 and FIG. 9, in particular from the viewpoint of differences from the embodiment 1. The same numerals shown in FIG. 8 and FIG. 9 with those of the embodiment 1 denote components of the same characteristics.

The light shielding device in the embodiment 2 is configured such that the light shielding device according to the embodiment 1 is additionally provided with a drive mechanism 130 which has a function of increasing and decreasing the buoyant force produced in the buoyant member 110. Similarly to that shown in FIG. 1, the drive mechanism 130 includes a driving unit configured to drive the shielding member 120, a movement controlling unit configured to control the driving unit, and a position detecting unit configured to detect a position of the shielding member 120.

The position detecting unit includes a GPS, and detects its three-dimensional position using the GPS. The movement controlling unit obtains a target three-dimensional position information indicating a target at which the light shielding device (the shielding member 120) should stay by the position inputting unit communicating with an operating station on the ground. In addition, the movement controlling unit moves the light shielding device 1 (the shielding member 120) using a driving unit 31 so as to adjust its three-dimensional position to the target three-dimensional position.

Further, the movement controlling unit outputs instruction information for changing the buoyant force of the buoyant member 110 for moving up and down to the buoyant member controlling unit as needed. The buoyant member 110 can change its volume, and, using a pump and a gas cylinder for helium gas included in a buoyant force increase-decrease mechanism (see the float function unit 61 in FIG. 3), decreases the helium gas in the buoyant member 110 to decrease the buoyant force based on the instruction information from the movement controlling unit 32, and increases the helium gas in the buoyant member 110 to increase the buoyant force based on opposite instruction information.

With the positional control of the shielding member 120 by the drive mechanism 130 thus configured, it is possible to shield the light to a moving object. When the shielding member 120 is configured as a huge device, it is possible to float in the air and cast a huge shadow. Therefore, by installing the shielding member 120 as large as an eye of a typhoon above the eye of the typhoon, it is possible to cool and make the shaded air heavier to increase the atmospheric pressure at the eye. With this, it is possible to reduce intensity of the typhoon.

Alternatively, other than reducing the intensity of a generated typhoon, it is possible to previously decrease a rate of occurrence of tornadoes or sand storms by installing a light shielding device up in the air in an area where tornadoes or sand storms are produced and by causing the device to move around continuously or intermittently to lower the temperature of the area as a whole uniformly under a certain value.

A specific example of the movement controlling unit in implementation can be performed similarly with a conventional unmanned airship whose moving position is remotely controlled. Further, when using an electric power as a moving power of the unmanned airship, it is possible to provide a solar cell on a surface of the light shielding unit 121 to obtain the power from the sunlight.

A function for increasing and decreasing the buoyant force of the buoyant member 110 is not particularly limited to the method described here, and it is possible to use the function used in a typical airship by helium gas. Further, the buoyant force increase-decrease mechanism can be provided accompanying the buoyant member 110, or can be provided accompanying the shielding member 120 or on a side of the drive mechanism 130.

The movement controlling unit can be configured to be performed by the operating station on the ground. At this time, the position detecting unit transmits self-position information that has been detected to the operating station on the ground. The operating station transmits movement control information indicating up, down, left, or right movement to the light shielding device 1, based on information of the target three-dimensional position and the position information transmitted from the position detecting unit. The driving unit moves the shielding member 120 based on the movement control information transmitted from the operating station. In this manner, the operating station performs information processing, based on the self-position information received from the light shielding device 1, for causing the driving unit to operate so that the shielding member 120 is moved to the target three-dimensional position.

Further, it is possible to employ a configuration in which the driving unit is removed from the drive mechanism, provided with an external connection terminal, and connected to external drive mechanism such as a remotely-controlled helicopter, and whereby the device is moved by being towed by the helicopter. In this case, the light shielding device 1 transmits the self-position information to the operating station on the ground as needed. The operating station calculates the movement control information indicating up, down, left, or right movement, transmits the movement control information via the light shielding device 1 to the remotely-controlled helicopter to drive the helicopter. In this manner, the operating station performs information processing and driving, based on the self-position information received from the light shielding device 1, for causing the remotely-controlled helicopter to take the shielding member 120 to the target three-dimensional position.

It should be noted that, as shown in FIG. 9, the relation between the light shielding unit 121 and the light transmitting unit 122 in the shielding member 120 is not limited to the example shown in FIG. 7. The rate of the areas of these components can be selected depending on a required degree of the light shielding. Specifically, the rate of the areas of the light shielding unit 121 and the light transmitting unit 122 can be 10 to 0.

Moreover, while the buoyant member 123 is provided along an entire outer circumference of the main body in FIG. 7, the buoyant member 123 can be provided along only a part of the outer circumference of the main body as shown in FIG. 5.

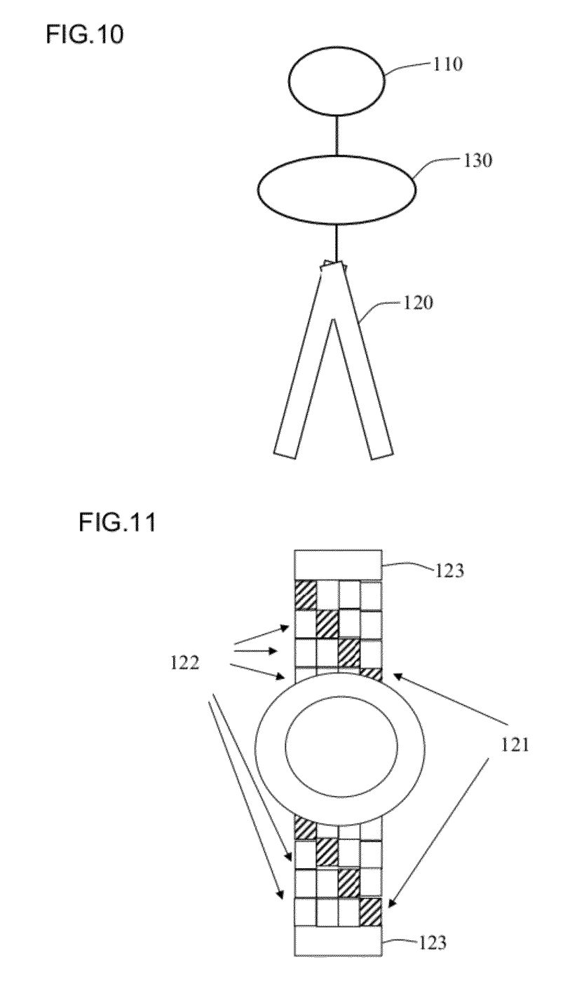

FIG. 10 shows the light shielding device shown in FIG. 8 and FIG. 9 in a state viewed from its side in which tension is reduced by discharging gas within the buoyant member 123 that constitutes the outer circumference unit of the main body, and FIG. 11 shows this light shielding device viewed from its top. However, even in the state in which the gas is discharged from the buoyant member 123 that constitutes the outer circumference, it is possible to maintain the buoyant force as a whole at the same level by adjusting the buoyant force of the buoyant member 110.

When the tension of the buoyant member 123 is reduced, or when the device moves down to an altitude at which the atmospheric pressure in the buoyant member is lower than the outside atmospheric pressure, the shielding member 120 that spreads horizontally before the reduction is folded in two and hangs substantially vertically. At this time, the device does not shield a large amount of sunlight beams. With this, when it is not necessary to shield the sunlight, it is possible to make an amount of solar radiation to the ground closer to the amount in a state without the light shielding device 1 keeping the light shielding device 1 installed.

In the above description, it is described that the amount of solar radiation to the ground is made substantially the same as that in the state in which the light shielding device 1 is not installed by folding the light shielding device 1. Alternatively, it is possible to make the amount of solar radiation to the ground closer to the amount in the state without the light shielding device 1 by purposely breaking the balance of the buoyant force of the shielding member 120 to incline the shielding member 120 substantially parallel with the sunlight.

In all of the above embodiments, the buoyant member 110 is made of vinyl. However, the buoyant member 110 can be made of any other material as long as the material is soft and impermeable to gas. However, it is preferable to use a material that is lightweight so as to prevent the own weight of the light shielding device from increasing, having high intensity so as not to be damaged easily.

Further, in the above description, the gas filled in the buoyant member 110 (and the shielding member 120) is helium. However, gas other than helium or mixed gas of a plurality of types of gas can be used as long as the gas is lighter than air in order to produce buoyant force.

Moreover, the buoyant member 110 can be damaged by birds and the like while installed in the air. Accordingly, it is preferable that more than several tens of buoyant members 110 are provided so that the buoyant force is not lost or the balance may not be broken when only a few members are damaged. And it is preferable that the buoyant members 110 are provided in a distributed manner rather than in a concentrated manner. In addition, it is possible to employ any method in order to realize each buoyant member. For example, it is possible to configure a single buoyant member by a single tube of cloth that transmits air filled with a plurality of small vinyl tubes filled with helium. Such buoyant members provided in a distributed manner may constitute the buoyant member 110.

Furthermore, in the light shielding device 1, the buoyant member 110 and the shielding member 120 are configured as separate components, but the shielding member 120 can also serve as the buoyant member 110. For example, it is possible to employ a configuration in which the light shielding unit 121 is additionally provided with a number of vinyl tubes filled with helium gas so as to completely integrate the shielding member with the buoyant member to omit the buoyant member 110. However, as lastly described in the description with reference to FIG. 1, it is preferable that resultant force of the buoyant forces is produced at and above a position close to the gravity center of the main body that corresponds to the center of the gravity position of the main body to realize the stability in the air. In addition, although the tubes of helium are used for the framework in the above example, it is possible to use carbon fiber or foamed polystyrene as the material of the framework.

When the altitude at which the light shielding device is installed is high, the air density or the atmospheric temperature is reduced, and this lowers the temperature of the buoyant members and the buoyant force decreases. Therefore, in order to increase the temperature of the buoyant members to maintain the buoyant force, it is possible to color the surface of the buoyant members in a color that easily absorb sunlight energy so that the temperature is increased receiving the sunlight energy depending on the altitude to be installed.

Further, in the above description, the shielding member 120 can be realized, for example, by processing cloth or vinyl in a form of a film so as to partially or fully shield the sunlight, and spreading the resultant substantially in parallel with the surface of the Earth if it is during the daytime.

In order to float the light shielding device as a whole in the air using the buoyant member 110, it is necessary to construct the light shielding device by components that are lightweight as much as possible. It is desirable that the weight of the light shielding device is no heavier than a few grams per square meter. For example, the round shielding member 120 whose radius is 1 km is about 3,100,000 grams, even when configured to be 1 gram per square meter.

The light shielding unit 121 and the light transmitting unit 122 in the shielding member 120 can be made of a material in a form of a film in order to save weight. Or it is also possible to fill the gas lighter than the air such as helium gas in tubes made of vinyl to produce buoyant force so that one or both of the light shielding unit 121 and the light transmitting unit 122 can also serve as the buoyant member.

Moreover, a shape of the shielding member 120 is not particularly limited. For example, the shielding member 120 can be rectangular when viewed from its top. In addition, the rate of the areas between the light shielding unit 121 and the light transmitting unit 122 can be determined considering the sunlight shielding ratio and the color of the surface.

The light shielding device 1 can be configured independently from a posture controlling method and a moving method of the light shielding device 1 as well as from a real-time buoyant controlling method.

Furthermore, in the above description, the aluminum foil is applied on the surface of the light shielding unit 121. However, it is possible to color the surface with various colors including a metallic color, and to allow a part of sunlight spectrums to pass by selecting a color. Alternatively, it is possible to provide a polarization function for shielding apart of sunlight spectrums. Alternatively, it is possible to provide a mirror surface by attaching such as an aluminum foil to the surface facing toward the Sun, thereby reflecting substantially all of the sunlight. Alternatively, it is possible to shield the sunlight by partially absorbing the sunlight with a portion colored by an arbitrary color including a metallic color such as silver. For example, if the color is black, all the spectrums are absorbed. In addition, it is possible to color the sunlight transmitting unit, and in this case, it is possible to increase the sunlight shielding ratio as a whole since the shield function is added to the sunlight transmitting unit. Further, by forming the sunlight transmitting unit in a letter or a symbol mark and coloring the sunlight transmitting unit, it is possible to use the sunlight transmitting unit as an advertisement as the letter is shown in colors when the light shielding device 1 is viewed from the ground.

The light transmitting unit 122 can be a space without vinyl, if it is allowed from the viewpoint of size of space, physical and structural force of the light shielding device, or the installation place. Further, by providing a cut line in a portion at which the light transmitting units 122 are connected to each other, it is possible to allow wind to pass through the light shielding device 1, or to allow water to drop through the light shielding device 1 toward the ground without remaining on the light shielding device 1.

When coloring the surface of the light shielding device facing toward the Sun to partially absorb and shield the sunlight, the absorbed sunlight energy there is converted to heat, and warm the air around the light shielding device. It is possible to employ a configuration such that the temperature of the buoyant member 110 is increased by this, and the temperature of the helium within the buoyant member 110 is raised to increase the buoyant force. Moreover, when coloring the buoyant member 110 in order to ensure the softness of the buoyant member 110, intending to warm the buoyant member 110 in whole, it is possible to color an inner surface of a lower section, instead of an outer surface of an upper section, of the member to warm helium in the buoyant member 110. The helium filled inside is enclosed, and it is possible to warm an interior as a whole that is in contact with helium, and to efficiently warm an entirety since the heat does not escape. When the outer surface is colored, heat easily escapes as the heat is produced at a portion in contact with external air. The method of increasing an interior temperature by the coloring of the inner surface of the buoyant member 110 can be utilized for other components in a similar manner.

By increasing the area of the shielding member, it is possible to cast a shadow over a large area such as a group of buildings and an athletic field. Therefore, a part of refrigerated air conditioning for the buildings present in the area is not necessary, and therefore it is possible to save the electric power and make economic, and whereby CO₂ can be reduced by an amount of the power consumption as a result. Further, since a certain area is cooled, in desert or tropical areas, for example, in India, it is possible to cool a city or an entire road of a certain area by shielding sunlight and casting a shadow by the light shielding device, thereby providing more bearable every day life.

Moreover, when the huge round light shielding device 1 whose radius is 10 km is installed at a position of 1 km above the ground and about 100% of the sunlight is shielded, it is dark even during daytime in an area under the shadow. Therefore, it is desirable to let a part of the sunlight pass in order to obtain certain brightness. Furthermore, in this case, other than the group of buildings, there are objects such as trees that need sunlight, and therefore it is necessary to limit installation of the device only to daytime of several days in high summer and to appropriately suppress an attenuation rate of sunlight.

Further, the light shielding device can be basically considered to cool a portion on the Earth under a shadow by shielding the sunlight by an amount of heat energy corresponding to the shielded sunlight energy. By this cooling effect, for example, it is possible to cool clouds to produce rain by installing the light shielding device above the clouds.

When casting a shadow on the ground using a building or a tent, typically, while the surface of the ground under the shadow is cooled, the shielded sunlight energy is converted into heat at the tent or the building, and warms the surrounding air, that is, the Earth. However, if the aluminum foil is provided on the surface of the shield functioning unit, the shielding of the sunlight cools a portion of the tent or the building under the shadow while the shielded sunlight can be radiated to the space, and whereby the Earth itself is cooled. Accordingly, by providing a number of light shielding devices in a distributed manner on the Earth, and by setting a surface area of these devices to be no smaller than a certain value, it is possible to make the sunlight energy received on the Earth to be no greater than a certain value, and thus it is possible to use the light shielding devices as a system for preventing the global warming.

The buoyant member 110, the light shielding unit 121, the light transmitting unit 122, and the buoyant member 123 can be configured so that the light shielding device 1 resumes the posture when the light shielding device 1 is turned upside down due to wind and the like. This can be realized by adjusting the magnitude of the buoyant force of the buoyant member 110 and a position at which the buoyant force works in the light shielding device 1 considering the balance between the buoyant force of the buoyant member 110, the light shielding unit 121, the light transmitting unit 122, and the outer circumference unit 123 and the weight of the other components.

### INDUSTRIAL APPLICABILITY

According to the present invention, it is possible to cast a shadow on the Earth by partially or fully shielding sunlight energy. A shaded portion on the Earth receives less sunlight energy and is cooled. For example, the temperature in a large city as a whole is high during daytime in high summer because of heat generation due to cooling devices, lighting equipments, and electronic devices such as computers in buildings in a large city, in addition to heating by sunlight. In a case in which the present invention is installed at high above this large city, it is possible to reflect and radiate sunlight energy into the space at a high altitude no lower than 100 m above the ground, and to prevent the sunlight energy from being converted into heat energy and radiated into the air. With this, it is possible to cool the city as a whole by shielding the sunlight and to make the city more bearable, as well as to reduce cooling operation of air conditioning devices, thereby reducing power consumption. Thus, the industrial applicability of the present invention is significantly large.

### REFERENCE SIGNS LIST

1 Light Shielding Device
11 Shielding Member
13 Buoyant Force Imparting Unit
15 Drive Mechanism Unit
21 Driving Unit
23 Rotating Unit
25 Controlling Unit
27 Position Detecting Unit
29 Position Inputting Unit
31 Surface Temperature Measuring Unit
33 Region Inputting Unit
35 Light Shielding Unit
37 Light Transmitting Unit
39 Opening
40 Valve
41 Buoyant Member
43 Buoyant Member Controlling Unit
47 Gas Adjusting Unit

1. A light shielding device, comprising:
a shielding member configured to shield a spectrum of sunlight at a predetermined altitude so as to change weather,
the predetermined altitude being a high altitude no lower than 100 m above the ground, and the shielding member having a function of reflecting and radiating a part or all of sunlight to itself toward a cosmic space; and
a buoyant force imparting unit configured to impart buoyant force to the shielding member, the buoyant force being imparted in a direction opposite of an own weight of the shielding member,
the buoyant force imparting unit
including a plurality of buoyant members provided for the light shielding device in a distributed manner and each filled with gas lighter than air, and
being configured to maintain the shielding member and an object that is engaged with the shielding member in a floating state in which the shielding member and the object are in a non-contact state with a surface of the ground, wherein
a part or all of the buoyant members constitute a main body of the light shielding device.

2. The light shielding device according to claim 1, wherein
the part or all of the buoyant members are adjusted such that an internal pressure of the gas lighter than the air in each of the buoyant members that constitute the main body of the light shielding device is lower than an outside atmospheric pressure on the surface of the ground and higher than the outside atmospheric pressure at the predetermined altitude, thereby maintaining a strength for keeping a shape at the predetermined altitude.

3. The light shielding device according to claim 1, wherein
the buoyant force imparting unit includes a buoyant member controlling unit configured to balance between a buoyant force of each of the buoyant members and own weight due to gravity of the main body of the light shielding device at a corresponding portion, and
each of the buoyant members includes a gas adjusting unit configured to individually adjust an amount of the gas lighter than the air filled into the corresponding buoyant member.

4. The light shielding device according to claim 1, wherein
the spectrum of the sunlight is shielded at a plurality of altitudes, and
each of the buoyant members that constitute the main body of the light shielding device is adjusted such that an internal pressure of the gas lighter than the air in the buoyant member is higher than an outside atmospheric pressure at one or more of the plurality of altitudes.

5. The light shielding device according to claim 1, further comprising:
a light shielding device rotating unit configured to rotate the light shielding device, wherein
a strength for keeping a shape is maintained also by a mechanism configured to pull the main body of the light shielding device outwardly by a centrifugal force produced by the light shielding device rotating unit causing the light shielding device to rotate.

6. The light shielding device according to claim 1, wherein
the shielding member includes an opening configured to allow passing of wind and/or dropping of water through toward the ground.

7. The light shielding device according to claim 6, wherein
the opening includes a valve, and
the valve opens in a case in which wind passes and/or water drops through toward the ground.

8. The light shielding device according to claim 1, wherein
a part or all of a surface of the shielding member is colored so as to absorb and shield the sunlight, and
converting an absorbed sunlight energy into heat increases a temperature of the gas lighter than the air.

9. The light shielding device according to claim 8, wherein
an inner surface of a lower section, instead of an outer surface of an upper section, of the buoyant member is colored, and
the temperature of the gas lighter than the air is increased also by a sunlight energy absorbed by coloring of the buoyant members.

10. The light shielding device according to claim 1, wherein
the buoyant member is configured by a soft film that prevents the gas filled therein from transmitting at the predetermined altitude, and the shielding member is configured in a form of a film so as to save weight.

11. The light shielding device according to claim 1, further comprising:
a driving unit configured to move the light shielding device;
a movement controlling unit configured to control the movement of the shielding member by the driving unit;
a position detecting unit configured to detect a position of the shielding member; and
a position inputting unit configured to input information on a predetermined position on the Earth, wherein
the movement controlling unit uses an output of the detection by the position detecting unit to make the shielding member move to a position inputted by the position inputting unit, move to and settle at the position inputted by the position inputting unit, or settle at the position inputted by the position inputting unit without moving.

12. The light shielding device according to claim 1, further comprising:
a driving unit configured to move the light shielding device;
a movement controlling unit configured to control the movement of the light shielding device by the driving unit; and
a surface temperature measuring unit configured to measure a surface temperature on the Earth, wherein
the movement controlling unit moves the light shielding device based on the surface temperature of the Earth measured by the surface temperature measuring unit.

13. A light shielding method using, in order to change weather, a light shielding device having a shielding member configured to shield a spectrum of sunlight and a buoyant force imparting unit configured to impart buoyant force to the shielding member to put the shielding member into a floating state,
the shielding member being configured by a film material,
the floating state being a situation in which the shielding member and an object that is engaged with the shielding member are in a non-contact state with a surface of the ground,
the buoyant force imparting unit including a plurality of buoyant members each filled with gas lighter than air,
the plurality of buoyant members
being provided in a distributed manner, and constituting a part or all of a main body of the light shielding device, and
including gas adjusting unit configured to individually adjust an amount of the gas lighter than the air,
the method comprising a step of imparting the buoyant force to the shielding member while balancing between the buoyant force of the plurality of the buoyant members provided in the distributed manner and own weight due to gravity of the main body of the light shielding device at corresponding portions by individually adjusting the amount of the gas lighter than the air filled in each buoyant member with the gas adjusting unit.

14. The light shielding method according to claim 13, further comprising a step of making the shielding member to which the buoyant force is imparted locate at a position no lower than 1 km above the surface of the ground and reflect the sunlight outside of the Earth.
